(19) United States
(12) Patent Application Publication
(10) Pub. No.: US 2010/0272532 A1
(43) Pub. Date: Oct. 28, 2010

(54) System and Method for Marking any Non-Living or Living Objects, and Marking Element and Use of Same for Marking any Objects, in particular for Object Control and Object Management

(76) Inventors: Viktor Hegedüs, Wehingen (DE); Armin Schrorer, Irndorf (DE)

Correspondence Address: GUDRUN E. HUCKETT DRAUDT, SCHUBERTSTR. 15A, WUPPERTAL, 42289, DE

(21) Appl. No.: 12/742,657

(22) PCT Filed: Nov. 13, 2008
(86) PCT No.: PCT/IB2008/003771

§ 371 Date: Jul. 4, 2010

(30) Foreign Application Priority Data
Nov. 13, 2007 (DE) 10 2007 054 716.3
Nov. 15, 2007 (DE) 10 2007 055 064.4

(51) Int. Cl. B23B 39/16; B23P 19/02

(52) U.S. Cl. 408/117; 29/525

(57) ABSTRACT

The invention relates to a system and a method for marking any non-living or living objects, in particular medical instruments, implants, structural parts, e.g. tools, machines, items of clothing, jewelry, and many others, and to a marking element and the use of same for marking any objects, in particular for object control and object management. For this purpose, a marking system is proposed that comprises a holding device for the object (82) that is to be marked, a marking element (70) with a round, oval or polygonal cross-sectional shape, and a drill device with which a receiving bore for the marking element is formed in the object that is to be marked, wherein the receiving bore has a cross-sectional shape corresponding to the cross-sectional shape of the marking element and has a cross-sectional surface area that is smaller than the cross-sectional surface area of the marking element, and a pressing device for pressing the marking element into the bore.

### TECHNICAL FIELD OF THE INVENTION

The invention concerns a system and a method for marking any non-living or living objects, in particular medical instruments, implants, components such as tools, machines, pieces of clothing, pieces of jewelry and many others, as well as a marking element and the use of the same for marking any objects, in particular for object control and object management.

### BACKGROUND OF THE INVENTION

For various reasons that will be explained in the following it may be desirable to mark living or non-living objects such as animals, instruments, implants, tools, machines, pieces of clothing, pieces of jewelry and many others with a marking that is e.g. colored. For this purpose, WO 2007/090378 A2 discloses a method for marking medical instruments in which onto the instrument to be marked a layer of a mixture of polymerizable acrylates or methacrylates or of a solid partially polymerized mixture of polymerizable acrylates or methacrylates is applied, whereupon the polymerization of the mixture is initiated and the mixture is cured on the instrument wherein the aforementioned applied layer itself is colored or is at least light-permeable such that it appears colored as a result of an underlying colored layer.

This method that is distinguished inter alia in that markings generated therewith stand great stress, for example, autoclave treatment, without being damaged has proven successful in practice. However, the application of the marking requires a certain know-how so that up to now usually this is done such that the manufactures of corresponding instruments transport them to a company that deals with marking of the instruments. This requires extra logistic expenditure that is undesirable for reasons of expenses as well as environmental concerns.

DE 100 14 542 C2 discloses to provide surgical instruments with a non-removable memory device in which an identification that individually identifies the respective instrument is saved wherein the memory device comprises a sender by which an electromagnetic wave field can be emitted for reading out the saved identification. However, it has been found that in practice it is extremely difficult to attach the appropriate memory device permanently to the surgical instrument.

In addition, it is known from a plurality of applications to provide wireless readable electronic components, so-called RFID chips, on an object to be marked which has the advantage that on the chip a plurality of information can be saved and utilized advantageously when a control of the object is done and the chip is read out. The greatest problem relating to this technology is however the attachment of the corresponding chip that, on the one hand, may not be completely shielded electromagnetically so that it can be read out at all and optionally also can be written on anew; on the other hand, it must protected from various loads, for example, dirt, sweat, dust, liquids etc.

### SUMMARY OF THE INVENTION

The invention has the object to provide a device and a method for marking of the aforementioned kind which device and method make it possible to provide the object to be marked, i.e., for example a medical instrument, a medical implant, a tool or the like (wherein the term “object” in the following is meant to encompass all kinds of living or non-living objects, including animals and humans) in a simple and easily applied way, with regard to the manufacturer of an object to be marked, in particular however also on the part of the user of a corresponding object, so that a robust marking is applied that also withstands loads, for example, an autoclave treatment of a medical instrument. In an advantageous configuration or embodiment it should also be possible to introduce special information into a marking element that is employed for marking which information surpasses by far the information contained in a pure color marking and, for example, can be read out by means of special reading devices, for example, a barcode or data matrix code reader, in particular however also by means of a RFID chip reader, and enables automated object control and automated object management. A further aspect of the invention is the automatic object control and object management enabled by means of such a marking element.

The object is solved by a device with the features of claim 1 and a method with the features of claim 33. The secondary claim 27 concerns a marking element for marking an object. The secondary claim 57 concerns a correspondingly marked object. Advantageous embodiments and further developments are the subject matter of the corresponding dependent claims.

Further details and advantages of the invention may be taken from the following purely exemplary and non-limiting description in connection with the drawings.

### BRIEF DESCRIPTION OF THE DRAWINGS

FIG. 1 shows a first embodiment of the marking element according to the invention in a side view.

FIG. 2 shows the marking element according to FIG. 1 in a plan view of the bottom side.

FIG. 3 shows a section of a receiving bore according to the invention in an object to be marked.

FIG. 4 shows a section of the bore according to FIG. 3 with inserted marking element according to FIG. 1.

FIG. 5 shows a greatly simplified schematic illustration of a drill according to the invention for introducing a receiving bore into an object to be marked.

FIG. 6 shows a schematic side view of a second embodiment of a marking element with introduced RFID chip wherein the position of the RFID chip is indicated by a dashed line.

FIG. 7 shows the marking element according to FIG. 6 in longitudinal section at the center according to the line VII-VII of FIG. 6.

FIG. 8 shows a plan view of the bottom side of the marking element according to FIG. 6.

FIG. 9 shows a section of an object with a receiving bore into which a marking element according to FIGS. 6 to 8 has been inserted.

FIG. 10 shows a section along the line X-X of the object according to FIG. 9.

FIG. 11 shows a third embodiment of a marking element in longitudinal section at the center.

FIG. 12 shows a basic schematic of a vacuum holder for a marking element in which a marking element can be secured for the purpose of pressing it into an object to be marked.

FIG. 13 shows a basic schematic of the vacuum holder according to FIG. 12 with inserted marking element.

### DESCRIPTION OF PREFERRED EMBODIMENTS

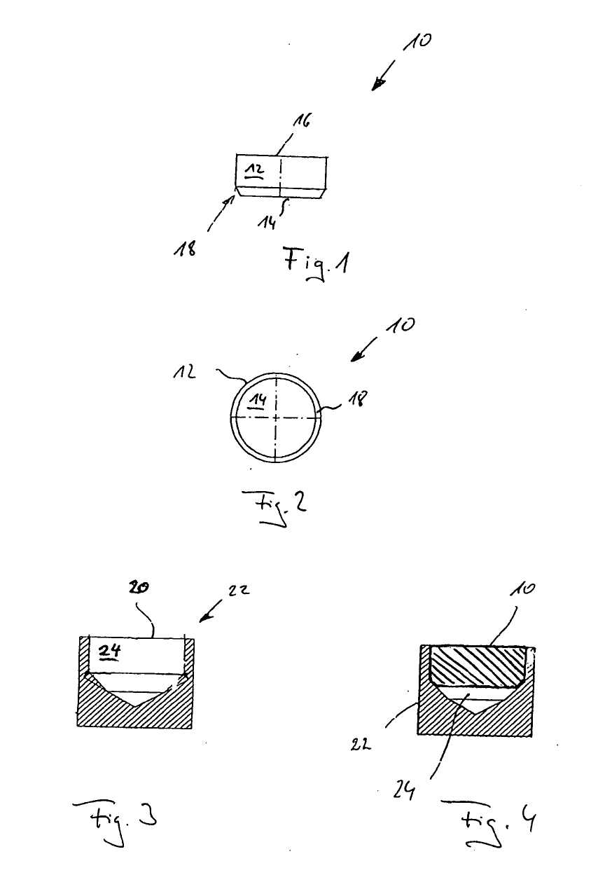

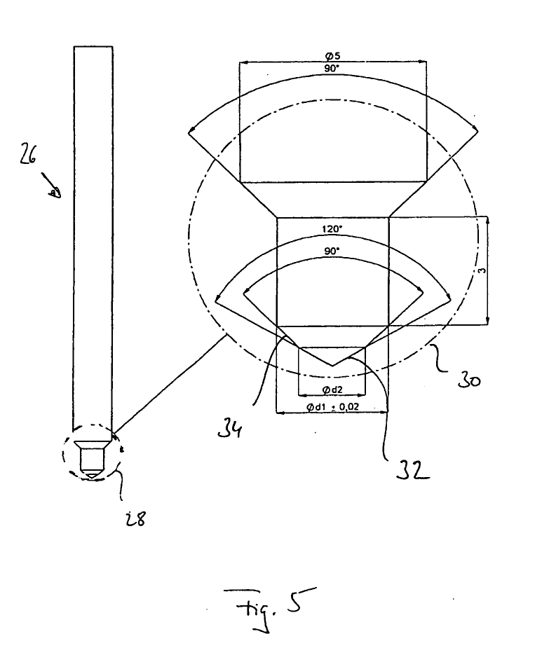

In FIGS. 1 and 2 a first embodiment of a marking element according to the invention, referenced as a whole by 10, is illustrated respectively in a side view (FIG. 1) and in a plan view of the bottom side (52), i.e., that side which in the proper mounting state faces the bottom of a receiving bore introduced into an object to be marked.

This embodiment of a marking element concerns a substantially circular-cylindrical component with an outer wall surface 12 and two end faces 14 and 16 wherein the outer wall surface 14 that is facing the bottom of a marking bore in the proper mounting state is beveled, i.e., a conical section, the so-called bevel 18, is formed at the transition area between the outer wall surface 12 and the end face 14. It should be noted in this connection that instead of circular-cylindrical marking elements also marking elements with other cross-sectional shapes, for example, oval or polygonal shapes, can be used. As a result of the simple configuration of the corresponding receiving bore however marking elements of circular cylindrical shape are preferred.

The bevel 18 facilitates on the one hand introduction of the marking elements into the receiving bore, serves as a centering aid and indicates on the other hand to the user which of the end faces is to face the bottom of the receiving bore.

The marking plug 10 is produced of a colored (including white or black), transparent or translucent plastic material. In particular, it can be of a multi-color configuration. In this connection it is possible to design the end face that is to face the bottom of the receiving bore in a color different than the remainder of the marking element and to mark it in this way so that an operator that operates a press for pressing in the marking element into a bore is able to orient the marking element in the correct way relative to the bore.

The marking element is comprised preferably of a plastic material whose thermal expansion coefficient is greater than the thermal expansion coefficient of the object to be marked, in particular greater than the thermal expansion coefficient of steel or stainless steel for titanium so that even when the marked object is exposed to a heat treatment, for example, a treatment in an autoclave, a safe pressfit of the marking element in the corresponding receiving bore is ensured. In this connection, it has been found, by the way, to be advantageous when the marking element is subjected to a heat treatment before introduction into the receiving bore.

The marking element can be comprised of polyether ether ketone (PEEK) or a polymerizable acrylate or methacrylate or a mixture of polymerizable acrylates and methacrylates. In particular, the marking plug can be comprised of a plastic material that can be cured by light, in particular UV light, or cured by pressure and/or temperature.

When the marking plug is comprised of a polymerizable acrylate or methacrylate or a mixture of polymerizable acrylates and methacrylates, the acrylates or methacrylates are preferably monomers with at least two acrylate or methacrylate groups, in particular difunctional or trifunctional methacrylates. In this connection, the monomers can be selected from a group that is formed of monomers forming tetraethylene glycol dimethacrylate, diethylene glycol dimethacrylate, ethylene glycol dimethacrylate, polyethylene glycol dimethacrylate; of monomers forming butanediol dimethacrylate, hexanediol dimethacrylate, decanediol dimethacrylate, dodecanediol dimethacrylate, bisphenol-A-dimethacrylate, trimethylol propane trimethacrylate, tetraethylene glycol diacrylate, diethylene glycol diacrylate, ethylene glycol diacrylate, polyethylene glycol diacrylate; butanediol diacrylate, hexanediol diacrylate, decanediol diacrylate, dodecanediol diacrylate, bisphenol-A-diacrylate, trimethylol propane triacrylate, their derivatives, and mixtures of these compounds.

The monomers may comprise also urethane dimethacrylate and/or tetraethylene glycol dimethacrylate or may be selected from the group that is formed of BIS-GMA and TEDMA, mixtures of these compounds and mixtures of these compounds with monomers selected according to claim 18.

Such a mixture moreover may comprise a preferably non-crystalline filler, in particular a filler selected from quartz sand, crystal-free highly dispersed silicon dioxide, aluminum oxide, ceramic, glass, silanized glass powder, glass ceramic, barium glass, and mixtures of these fillers.

Such a mixture may then comprise 70 to 90% by weight, preferably 79% by weight, BIS-GMA; 10 to 30% by weight, preferably 20% by weight, TEDMA; and 0 to 3% by weight, preferably 1% by weight, crystal-free highly dispersed silicon dioxide such that the sum of the components of the mixture is 100% by weight. Moreover, the mixture may be polymerized by a photoinitiator, in particular a photoinitiator that has an activation wavelength of 400 to 500 nm, preferably 470 nm.

The aforementioned photoinitiator is preferably selected from the group that is formed of benzophenone, benzoin, an alpha-diketone, acyl phosphine oxide, camphor quinone and their derivatives as well as mixtures of these photoinitiators.

Alternatively, the mixture can be at least partially polymerized at a pressure above 1 bar, in particular above 2 bar, and a temperature above 100° C.

In FIG. 3 a section in the area of a receiving bore 24 of an object 22 that is only schematically indicated, i.e., by a rectangular contour 20, is shown.

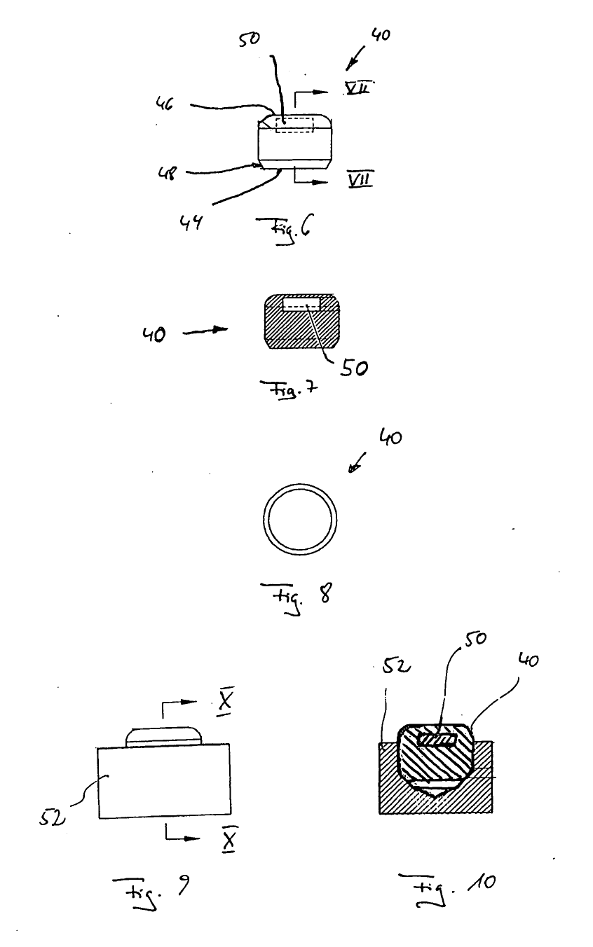

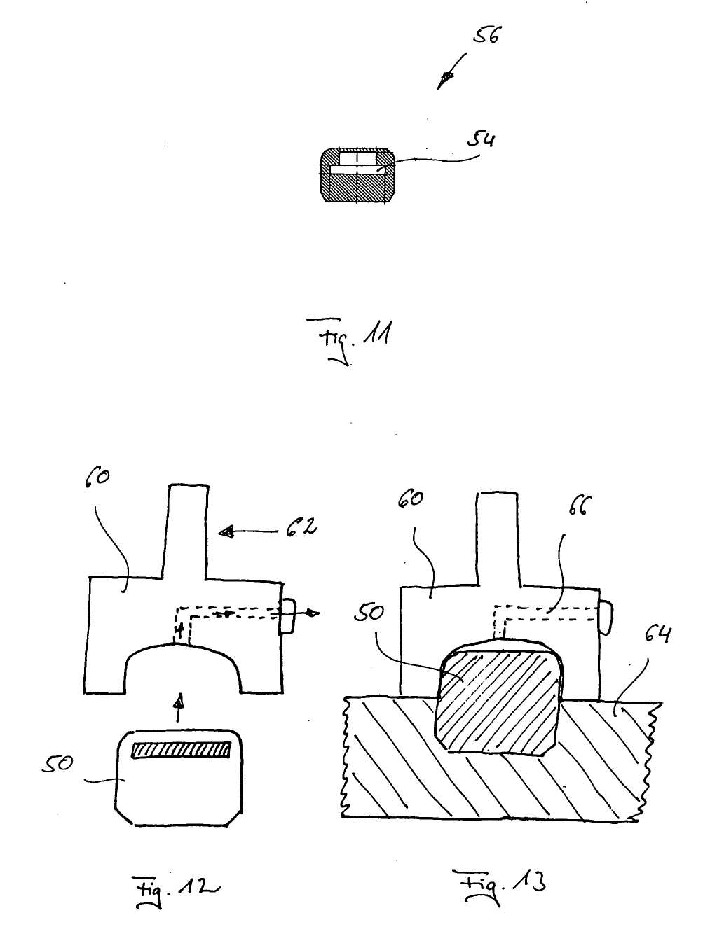

It can be seen clearly that the receiving bore 24 at the bottom has two conical sections with different slant relative to the center axis of the bore that are produced as a result of use of the special drill for introducing the bore indicated schematically in FIG. 5. This per se unusual shape of the bottom that, as can be seen in FIG. 4, is unnecessary per se for introducing the marking plug serves as an identification and quality insuring means: size and depth of the bore are matched to the marking plug according to the invention in such a way that the cross-sectional surface of the bore is somewhat smaller than the cross-sectional surface of the employed marking element.

In order to prevent that between the inner wall of the bore and the outer wall of the marking element, for example, bacteria or the like can settle, a precision manufacture of the bore is required. Since appropriate precision drills are more expensive than a simple drill, some users may be inclined to employ simple drills for introducing the receiving bore. As a result of the special shape of the bottom it is then easily possible to determine in case of any complaints whether a precision drill that is part of the marking system has been employed for introducing the receiving bore.

In FIG. 4 a section of the object 22 in the area of the receiving bore with inserted marking element 10 is illustrated. The marking element has a certain elasticity and typically a diameter that is approximately 1 to 20, preferably approximately 2 to 10%, even more preferred approximately 2.5 to 4%, greater than the diameter of the receiving bore, wherein in one embodiment the diameter of the cross-sectional surface, when pressed into the receiving bore, is reduced correspondingly by compression of the marking element.

In another currently especially preferred embodiment the marking element is, with respect to the diameter, again somewhat greater than the receiving bore but upon pressing into the receiving bore is not at all or only minimally compressed by the conical (beveled) centering surface at the transition area between an end face and the outer wall surface. Instead, excess material upon introduction of the marking element is sheared off at the top edge of the receiving bore so that an especially tight and stable pressfit results. A marking element that is provided for such a pressfit has preferably a substantially circular-cylindrical shape so that upon introduction of the marking element no alignment work must be done as would be the case for a marking element with oval or polygonal cross-section.

In FIG. 5 in greatly simplified illustration a drill, referenced as a whole by 26, embodied according to the invention is shown for introducing round receiving bores into an object to be marked wherein only the outer contours but not the individual cutting surfaces of the drill are illustrated.

The area of the tip of the drill that is marked by the dashed circle 28 is illustrated enlarged in the dash-dotted circle 30. It can be clearly seen that the tip of the drill has two sections 32 and 34 that are slanted differently relative to the center axis of the drill and that effect the embodiment of the bottom of a corresponding bore as described in connection with FIG. 3. The slants are selectable at will. In particular, the first area can be slanted more toward the center axis, i.e., relative to the center axis of the drill can have a smaller angle than the second area. Also, more than two areas with different slants can be provided.

It is understood that already by colored marking elements a marking that is satisfactory for many applications can be effected. For example, a dentist who has several treatment rooms may mark the instrumentation sets that are to be at his disposal in the individual rooms with different colors.

In this connection, completely or partially transparent marking elements may be used wherein then into the receiving bore a colored element or a colored layer is applied before pressing in the marking element. This element or this layer may even be comprised of a thermochromic color with irreversible color change.

An especially preferred embodiment of the invention however provides that in the marking elements an information element, in particular a company logo, a barcode, a data matrix code, an RFID chip or a combination of the aforementioned elements is introduced, for example, by potting.

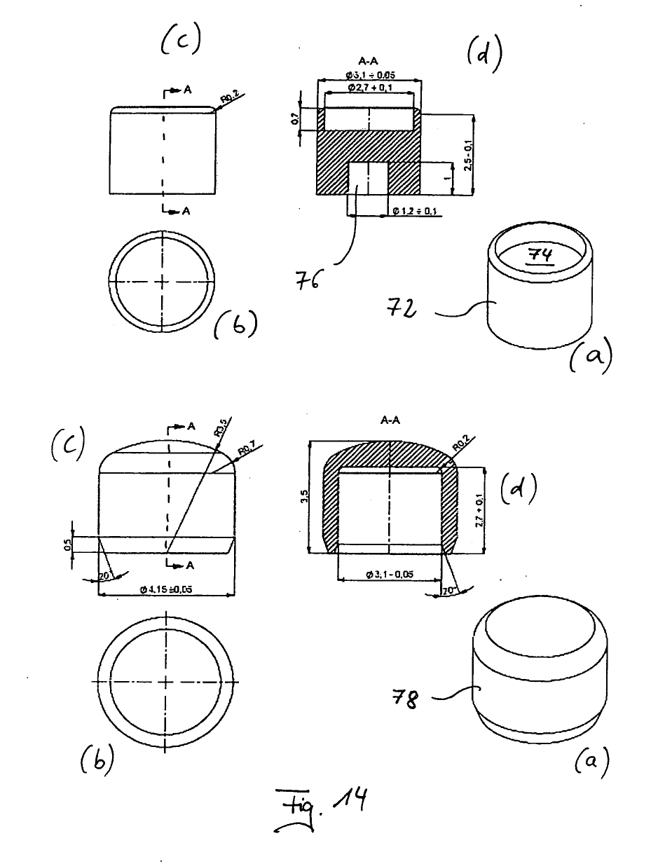

In FIGS. 6, 7 and 8 an embodiment of a marking plug 40 according to the invention is illustrated in which such an information element, here in the form of an RFID chip, is provided.

The marking element 40 also has, like the marking element 10, a substantially cylindrical shape with an outer wall surface 42 and 2 end faces 44 and 46 wherein the lower outer wall surface 44, i.e., the one that in the proper mounting state is facing the bottom of a corresponding receiving bore, is also provided with a bevel 40.

As indicated in FIG. 6 by the dashed line, into the marking element 40 an RFID chip 50 has been introduced which in this embodiment is potted in the marking element. However, it is also advantageously possible to arrange such an RFID chip in various other ways in a marking element according to the invention; this will be explained in the following.

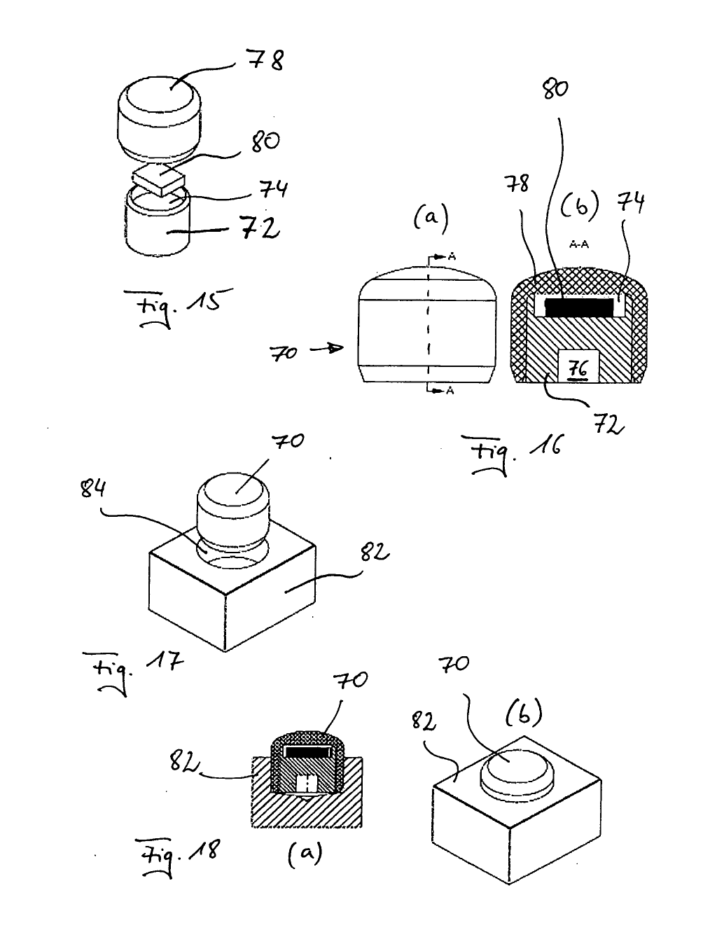

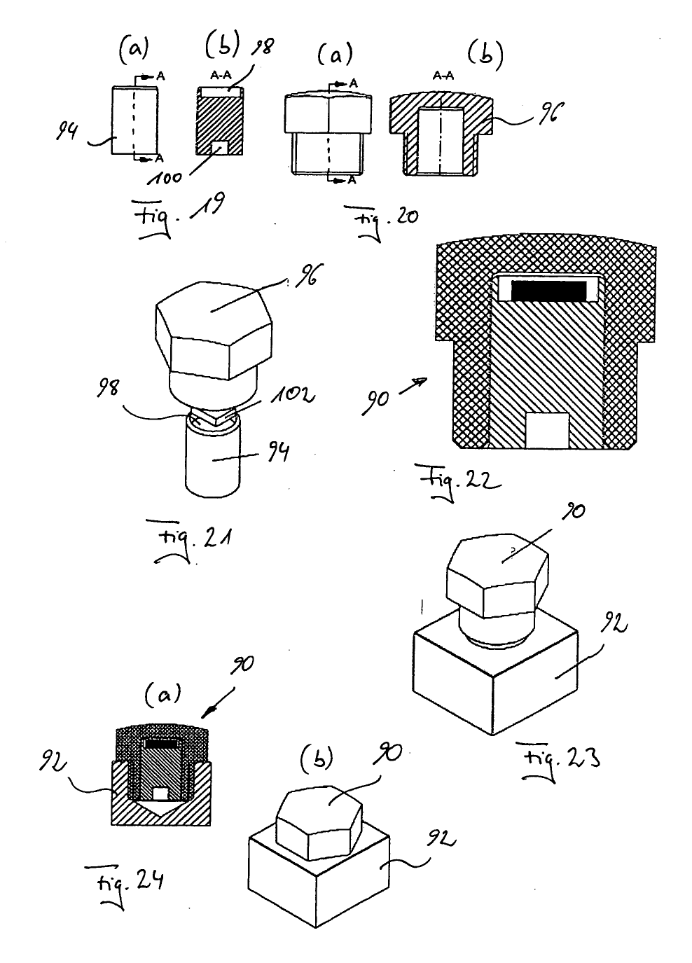

The marking element in this embodiment is somewhat taller than the marking element shown in FIG. 1 so that, as shown in FIGS. 9 and 10, upon introduction into a bore that corresponds to the one shown in FIG. 3, it projects slightly from the object 52 to be marked. This is desired in this embodiment in order to improve the sending properties of the RFID chip, i.e., to improve its readability by appropriate reading devices. However, it should be noted in this context that, depending on the configuration, in particular the size of receiving bore and marking element, it is indeed possible to arrange the RFID chip such in the marking element that it is located entirely within the receiving bore and, despite of this, can still be read out so that the marking element must not project from the receiving bore but, as shown in FIG. 4, is flush with the upper edge of the receiving bore.

For improving the sending properties, as illustrated in FIG. 11, into the marking element in the proper mounting state below, i.e., closer to the bottom of a receiving bore, a sending amplification element, in particular, a ferrite lamella 54 can be provided. In other respects, the marking element 56 illustrated in FIG. 11 corresponds to the marking element illustrated in FIGS. 6 through 8.

The use of the aforementioned information element in the marking element makes it possible, in addition to a pure color marking, to store and easily automatically retrieve a plurality of information, in particular when using RFID chips. In this way, a counting control of the instruments in the operation theater is possible before as well as after surgery. In addition, the information element may have saved therein information that relates to or contains, for example: operating manuals; medical risk classification of the instrument; cleaning and disinfection instructions; sterilization instructions; cleaning, disinfection and sterilization data, for example, information in regard to date and time of the cleaning/disinfection/sterilization performed last, frequency of use and expiration date of the instrument, repair instructions, and repair data as well as, naturally, certain manufacturer information including, for example, in case of implants, information about the date and location of implantation, of the attending doctor or further patient-specific data.

The use of RFID chips as information element has several great advantages that are expressly encompassed and claimed by the invention. In contrast to information elements that work “at sight”, for example, barcodes or data matrix codes that, in case of soiled objects, for example, surgical instruments after their use in surgery, can possibly only be read after cleaning, the RFID chips are readable independent of the degree of soiling of the object and, moreover, readable completely automatically. Also, the chips are resistant, for example, with respect to manipulations often performed during repair work or manipulations performed thereon would be immediately apparent. For example, in case of repair of certain surgical instruments it is conventional to grind them and to therefore also remove certain manufacturer information. The repaired instruments can then however no longer be differentiated with regard to manufacturers because sometimes, with regard to their shape, they are exactly identical. With marking elements provided with RFID chips it is now possible to exactly follow the “career” of an instrument or other object. An especially important use is the subject matter of claim 67. In addition to the known counting control (completeness of the instrument set) it is possible for the first time to make a differentiation which instruments have been actually used so that in case of future operations instruments that have been rarely or never used but belong to the standard instrument set no longer must be automatically made available on a so-called support screen and after the operation, independent of whether they have been used or not, must no longer be sterilized in a complex process. Instead, such instruments can be separately packaged and may be unpacked only if needed; this is an important economic advantage.

The described marking elements and the described drill form parts of a marking system that moreover comprises a holding device, not illustrated here, for an object to be marked, a drilling device for introducing the receiving bore for the marking element into the object to be marked by means of the illustrated drill, and a pressing device for pressing the marking element into the receiving bore. In this way, it is possible to provide manufacturers or users, for example, hospitals, with a system that makes it possible for them to mark the respective objects themselves in a reliable fashion. When marking elements with RFID chips are used, an appropriate device for reading out and/or writing on the RFID chips completes the system.

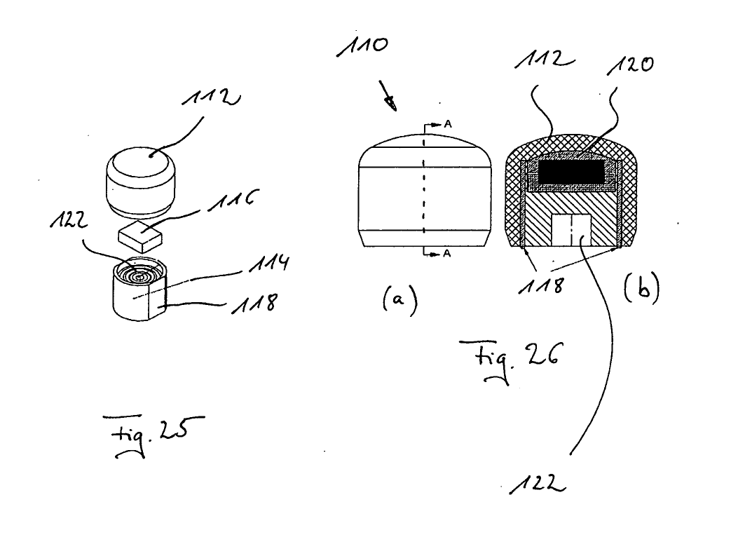

In FIGS. 12 and 13 a holder, referenced as a whole by 60, for a marking element is illustrated, for example, for a marking element 50 as illustrated in FIG. 6. The holder has a section 62 that is designed such that the holder can be inserted into a conventional receptacle for a drill. In this way, the holder 60, after a bore has been produced in an object to be marked, can be inserted into the drilling device, usually comprising means for movement of the object to be marked relative to the drill, in exchange for the drill so that then after insertion of the marking element into the holder, the holder can be moved relative to the object to be marked so that the marking element is pressed into the bore previously introduced into the object to be marked. This has the advantage that the object to be marked that has already been aligned relative to the drilling device must not be changed. FIG. 13 shows the situation where the holder 60 has been lowered onto an object 64 to be marked after prior insertion of a marking element 50 into the holder 60 and, in this way, the marking element 50 is pressed into the object.

The holder that has been illustrated in FIGS. 12 and 13 comprises advantageously a passage 66 indicated by dashed lines that is connectable to means, not illustrated in detail here, for generating a vacuum, so that a marking element that has been introduced into the holder 60 can be secured in the holder by applying a vacuum. In a preferred embodiment, the receptacle that is formed in the holder 60 for a marking element is designed such that the pressure that is applied by the holder onto the marking element upon pressing into an object to be marked is limited substantially to the edge areas of the marking element so that an information element that is possibly contained in the marking element, thus in particular an RFID chip, upon pressing of the marking element into the object to be marked will not be damaged.

FIG. 14 shows the two parts 72 and 78 insertable into one another of an especially preferred embodiment of a marking element according to the invention in different illustrations that are self-explanatory to a person skilled in the art. In the upper half of FIG. 14 the part 72 that is arranged substantially in the interior of the part 78 in the proper mounting state is illustrated in a perspective illustration (a), in plan view of the top side (b), in side view (c), and in section along the line A-A (d). Easily recognizable is a receptacle 78 in the upper area of the part 72 which receptacle is cylindrical in this embodiment into which upon mounting of the marking element an information element, in particular an RFID chip, may be inserted.

Part 72 has in this embodiment at its bottom side a bore 76 that serves for improved handling of the part and in particular of the finish-mounted marking element.

The part 78 shown in the lower area of FIG. 14 is shown, analog to part 72, in perspective illustration (a), in plan view onto the top side (b), in a side view (c), and in section along the line A-A (d). The part 78 is substantially formed like a cap into which the part 72 can be inserted. In this connection, the dimensions are such that upon insertion, more precisely, upon pressing in the part 72 into the part 78, a secure seat is provided.

FIG. 15 shows schematically the assembly of a marking element according to the invention comprising a part 72 with a receptacle 74 for an RFID chip 80 and a part 78. It should be noted in this context that the parallelepipedal chip 80 in this embodiment, of course, can have also any other suitable shape in particular a cylindrical shape. As will be explained in the following, the cavity that remains after insertion of the chip 80 into the receptacle 74 can be filled out, for example with silicone; however, it has been found that this is not necessary in most cases.

FIG. 16 shows a completely assembled marking element, as a whole referenced by 70, in a side view (a) and in a section along the line A-A.

FIG. 17 shows in a perspective view the situation shortly before marking any non-living object 82 into which a receiving bore 84 for receiving the marking element 70 is introduced.

FIG. 18 shows in section at the center (a) and in perspective view (b) the situation after introduction of the marking element 70 into the object 82 to be marked in which it is safely held by pressfit in the receiving bore.

FIGS. 19 to 24 show a further embodiment of a marking element according to the invention that is suitable especially for use as an industrial plagiarism protection. The marking element, referenced as a whole by 90, is in this connection embodied like a screw and, as illustrated in the FIGS. 23 and 24 schematically, can be screwed into any component 92 provided with an appropriate threaded bore. In this connection, the marking element embodied like the marking element illustrated in FIG. 16 comprises a part 94 that in FIG. 19 is shown in a side view (a), in section along the line A-A (b), and that is pressed into a part 96 that is shown in FIG. 20 in a side view (a) and in section along line A-A (b). In this connection, the part 94 has again two receptacles or bores 98 and 100 of which one (100) serves for improved handling, the other (98) for receiving an RFID chip 102.

FIG. 25 shows a further embodiment of a marking element according to the invention that, as a whole is referenced by 110, and is comprised of a part 112 and a part 114 that between them form a cavity for an information element, in particular an RFID chip 116. In this embodiment, the essentially cylindrical part 114 has at two locations on its outer wall surface flattened portions 118 that enable an adhesive and sealing material, as in particular silicone, as can be seen in particular in FIG. 26, to escape from the marking element. Assembly of this embodiment is realized such that into the receptacle 122 formed in the part 114 a substance such as in particular silicone is filled in into which then the chip 116 is inserted. The substance in general is a substance that cures by drying or heat. When the substance is at least partially cured, onto the chip 116 a certain quantity of the substances is applied also whereupon the part 112 is placed onto the part 114 and pressed onto it. When doing so, the excess substance can then escape through the passages that are formed between the surfaces 118 and the inner walls of the part 112. After curing of the substance, a marking element is formed in which the inserted information element is safely secured.

### INDUSTRIAL APPLICABILITY

In particular the marking element according to the invention enables numerous industrial applications not only for the described detection of information in case of medical instruments but also in particular in connection with protection against plagiarism. Marking elements according to the invention can be inserted in various ways into the objects that are to be marked. When the marking element is produced of suitable biocompatible material such as in particular certain plastic materials, it can also be used for marking living objects, for example, animals. Accordingly, the application implies also various new business methods, i.e., in particular the industrial marking of objects of various kinds with marking elements according to the invention, in particular with marking elements with wireless readable information elements such as in particular RFID chips. In this connection, the providers of such markings can also offer to their clients to introduce certain information that can be read out only by them into the information elements in order to ensure a high protection against piracy products. These methods are thus expressly encompassed by the invention and are claimed accordingly in those countries whose national laws permits this.

What is claimed is:

1.-70. (canceled)

71. A marking system for marking an object, the marking system comprising:
a holding device for an object to be marked;
a marking element with round, oval or polygonal cross-sectional shape;
a drilling device for introducing a receiving bore for the marking element into the object to be marked, wherein the receiving bore has a cross-sectional shape that matches the cross-sectional shape of the marking element and has a cross-sectional surface that is smaller than a cross-sectional surface of the marking element;
a pressing device for pressing the marking element into the receiving bore;
wherein the marking element is dimensioned and designed such that a portion of an outer surface of the marking element, when the marking element is pressed into the receiving bore introduced into the object to be marked, is sheared off at edges of the receiving bore and the marking element is secured by pressfit in the receiving bore.

72. The marking system according to claim 71, wherein the marking element has a height that is greater than a depth of the receiving bore.

73. The marking system according to claim 71, wherein the marking element is comprised of a plastic material having a thermal expansion coefficient that is greater than a thermal expansion coefficient of the object to be marked.

74. The marking system according to claim 73, wherein the thermal expansion coefficient of the plastic material is greater than the thermal expansion coefficient of steel or stainless steel or titanium.

75. A marking element for marking an object, wherein the marking element is provided for introduction into a receiving bore for the marking element in an object to be marked, wherein:
the marking element has a round, oval or polygonal cross-sectional shape;
the marking element is comprised of plastic material that is colored, including black or white, transparent or translucent;
wherein the marking element comprises two parts inserted into one another;
wherein the two parts define a cavity for receiving an information element and protecting the information element from environmental effects.

76. The marking element according to claim 75, wherein the plastic material has a thermal expansion coefficient that is greater than a thermal expansion coefficient of steel or stainless steel or titanium.

77. The marking element according to claim 75, comprising an information element inserted into the cavity.

78. The marking element according to claim 78, wherein the information element is selected from the group consisting of a company logo, a barcode, a data matrix code, an RFID chip, and a combination of the aforementioned elements

79. The marking element according to claim 78, comprising an information element that is an RFID chip introduced into the cavity.

80. The marling element according to claim 79, comprising a sending amplification body, wherein the sending amplification body, in a direction of the object to be marked, is arranged below the RFID chip in the cavity.

81. The marking element according to claim 80, wherein the sending amplification body is a ferrite lamella.

82. The marking element according to claim 75, wherein the plastic material is polyether ether ketone (PEEK) or a polymerizable acrylate or methacrylate or a mixture of polymerizable acrylates and methacrylates.

83. The marking element according to claim 75, wherein the plastic material cures by pressure or temperature or by a combination of pressure and temperature.

84. The marking element according to claim 75, wherein a first one of the two parts is a cap in which a second one of the two parts is inserted, wherein dimensions of the two parts are chosen such that, when pressing the two parts into one another, a secure seat of the two parts relative to one another is provided.

85. The marking element according to claim 75, wherein the marking element has an elasticity selected such that the cross-sectional surface of the marking element, when the marking element is pressed into receiving bore, is reducible by compression by 1 to 20%.

86. The marking element according to claim 75, wherein the marking element has an elasticity selected such that the cross-sectional surface of the of the marking element, when the marking element is pressed into receiving bore, is reducible by compression by 2 to 10%

87. The marking element according to claim 75, wherein the marking element has an elasticity selected such that the cross-sectional surface, when the marking element is pressed into receiving bore, is reducible by compression by 2.5 to 4%.

88. A method for marking an object, the method comprising the steps of:
manufacturing a marking element as a cylindrical body provided a round, oval or polygonal cross-sectional shape and having an outer wall surface and two end faces, wherein the marking element in a transition area between the outer wall surface and one of the end faces is beveled;
introducing a receiving bore for the marking element into an object to be marked, wherein the receiving bore has a cross-sectional shape that matches a cross-sectional shape of the marking element and has a cross-sectional surface that is smaller than a cross-sectional surface of the marking element, and
pressing the marking element into the receiving bore and securing the marking element by pressfit in the receiving bore.

89. The method according to claim 88, comprising the step of subjecting the marking element to a heat treatment before introduction into the receiving bore.

90. The method according to claim 88, comprising the step of introducing into the marking element an information element.

91. The method according to claim 90, comprising the step of selecting the information element from the group consisting of a company logo, a barcode, a data matrix code, an RFID chip or a combination of the aforementioned elements.

92. The method according to claim 88, comprising the step of introducing into the marking element an RFID and a sending amplification body.

93. The method according to claim 92, wherein the sending amplification body is a ferrite lamella.

94. An object marked by a marking element according to claim 75.

95. A method of controlling use of a medical instrument in a medical operation for the purpose of differentiating instruments used or not used during operation for obtaining information with respect to which instruments of an instrument set during an operation in general are actually used and which instruments are not used, comprising the step of providing the medical instrument with a marking element according to claim 75.
